(19) United States
(12) Patent Application Publication
(10) Pub. No.: US 2015/0028554 A1
(43) Pub. Date: Jan. 29, 2015

(54) HAND TRUCK SYSTEM WITH REMOVABLE BIN

(71) Applicant: Irwin SCHNEIDER, MASSAPEQUA, NY (US)

(72) Inventor: Irwin SCHNEIDER, MASSAPEQUA, NY (US)

(21) Appl. No.: 14/277,510

(22) Filed: May 14, 2014

Related U.S. Application Data
(60) Provisional application No. 61/858,273, filed on Jul. 25, 2013.

(51) Int. Cl. B62B 1/14

(52) U.S. Cl. CPC B62B 1/14
USPC 280/47.26

(57) ABSTRACT

A wheeled hand truck system is provided having a removable and/or stackable bin or container formed by sidewalls and a bottom surface, the container having a plurality of leg slots and strap slots on one or more of the side walls, and a plurality of base plates secured to or formed with the exterior of the bottom surface and configured for engaging with a load supporting platform or support blade of a hand truck. The truck system may be configured for utilization of one or more bins or containers. More specifically, provided is a combination hand truck and bin that comprises a body, a load supporting platform or support blade, an axle, a wheel assembly having a pair of wheels, a bin or container, and a restraining device for retaining the bin or container securely on the platform or blade of the hand truck.

### CROSS REFERENCE TO RELATED APPLICATIONS

This application relates to and claims priority from U.S. Prov. Ser. No. 61/858,273 filed Jul. 25, 2014, the entire contents of which are incorporated herein by reference.

### FIGURE SELECTED FOR PUBLICATION

FIG. 2

### BACKGROUND OF THE INVENTION

1. Field of the Invention

The present invention relates generally to the field of hand trucks, also referred to as hand carts or dollies, for transporting objects. More specifically, the invention relates to transportable hand trucks having removably secured bins for the easy collection and/or transport of a variety of objects, yard waste and/or debris.

2. Description of the Related Art

There is a widespread need to facilitate the manual transportation of objects, materials, heavy boxes, articles, or other loads, as well as yard, house, and industrial debris. In the past, a variety of handcarts or hand trucks, commonly referred to as dollies, have been proposed. The basic hand truck comprises an elongated, tubular body or frame having a handle mounted or formed at an upper end thereof and a load support platform that extends perpendicularly from a lower end thereof, and a pair of wheels connected by an axle. A flat support platform or support blade or member is provided at the lower portion of the frame for sliding under an article to be moved. When the user pivots the handle toward himself or herself, the base plate pivots upward and the frame is supported entirely by the wheels.

That is, in the use of a conventional hand truck, a user places the hand truck in a rest position, in which the body is substantially vertically oriented so as to be perpendicular to a ground or floor surface. In this position, the user places one or more items or other load on the support platform. To maneuver the load, the user tips the hand truck into an inclined position by tilting the body or frame backwardly relative to the load on the platform to thereby elevate the load such that the body and the load are supported on the wheels. In this position, the support platform is no longer on the ground and the weight of the load is supported by the body or frame and the wheels. As a result, an article resting on the base plate may then be wheeled from one location to another. Various versions and adaptations of the basic hand truck exist to provide additional functionality in certain situations. For example, in some embodiments, the hand truck is convertible from an upright two wheeled hand truck to a horizontal four wheeled hand cart. In other embodiments, the basic hand truck includes horizontally extending arms or forks that help in securing large items on the hand truck.

While various adaptations of the basic hand truck have been made, these various adaptations are not useful in all situations. It would be desirable if a hand truck could be further modified such that certain types of machines or other apparatus could be situated more securely on the hand truck. For example, hammer drills are often moved using a hand truck, but present embodiments of the hand truck do not seem particularly well suited to moving hammer drills. Accordingly, it would be desirable to provide a hand truck that facilitates easy movement of various objects or waste. However, many traditional hand carts have the bin or storage space as an integral, undetachable portion of the device, and thus, the functionality of the device is limited. Accordingly, numerous devices have been developed and commercialized for the transport of objects or materials and the collection of trash, leaves and other refuse.

It is common to use refuse containers such as plastic tubular cans for holding outdoor refuse such as leaves, branches, garbage, and the like. Typically, these containers must be kept in an upright standing position to be used. However, the upright standing position generally requires the user having to physically bend and pickup the refuse with one's hands to place it into the standing container.

For example, some such devices provide a frame for supporting and transporting a garbage collecting bag where the bag is attached to the top of the frame. The frame has a dustpan extending from one end and is designed so that refuse can be swept through the dustpan and into the bag when the device is placed in a horizontal position. When placed in an upright position, the bag rests on wheels that make the device easily portable. The frame far the device in the two related patents is dimensionally adjustable.

Another such device is a one-piece, plastic dustpan and basket combination. Debris may be swept directly into the retention basket by placing the device in a horizontal position whereby that the dustpan is placed in position to receive the debris. When in its upright position, the device serves as a trash storage container.

However, the upright standing position generally requires the user having to physically bend and pickup the refuse with one's hands to place it into the standing container. In addition to the undesirable physical movements, it is usually undesirable to physically touch the refuse even if one uses gloves. Furthermore, physically lifting up and moving the refuse usually results in some debris dropping out and having to be picked up again. Users have also been known to try and lay the tubular containers on their sides. However, the circular opening to the container makes it difficult and near impossible to sweep, rake, and move the refuse into the container. Also, some carts were typically unable to be effectively placed in a horizontal position to facilitate the insertion and removal of objects, debris and other materials. Moreover, of those cart designs that can be placed in a horizontal position, many do not provide a ramp means for the user's ease in sweeping, raking, or otherwise sliding the debris or other materials into the cart.

Over the years various types of containers have been proposed for storing and/or carting waste or other objects that is different from tubular containers. For example, some containers have substantially D-shaped outer wall shapes for handling debris. However, these containers have their opening ends having at least and preferably larger interior diameter sized spacing than their closed ends, which makes the containers difficult if not impossible to stand on their closed bottom ends. Furthermore, filling these containers with debris creates an unstable container since the interior weight is concentrated toward the upper open ends and would tend to cause the containers to fall over spilling their contents out. Furthermore, all of these containers must be physically lifted and carried to be moved which makes them difficult when filled to be mobile. In addition, some have pivotal lids that would have to be physically removed in order to effectively push debris into those containers.

Also, some disclose debris containers having side walls forming rectangular shapes that also have their open ends be larger in interior cross-section than their closed bottom interior ends so that filling up the containers causes a stability problem when trying to vertically stand the container up since more weight is adjacent the upper open end than the closed end. These containers would also tend to fall over and spill their contents out.

Still others are cylindrical containers having rectangular flat side walls, and similarly have larger sized upper open ends than the closed bottom ends. The containers are not very stable when filled with debris and can easily tip over and spill the container contents when being used. Further, others only have handles on left and right sides of the containers which make it difficult to lift from horizontal to standing positions and vice versa. Also, both containers have raised rectangular shaped lip edges adjacent their upper open ends making it difficult to push debris over the bump like edges into the containers. Additionally, the small flat mouth edges of these references are much too small to allow traditional 24 inch wide brooms and rakes enough space to effectively sweep debris into the containers. Still furthermore, some only allow for a separate dolly to make their container more mobile. However, this separate dolly would add unnecessary space, assembly, and expose requirements in order to be effectively used.

None of the prior hand trucks or bins, however, discloses or teaches the novel features of the present invention as disclosed herein. Accordingly, an improved hand truck is needed that has a removable and refastenable bin that is stackable and securable to a standard hand truck. Also needed is a bin or container ribbed for added strength and/or shaped for easy dumping. Also needed is a bin having handles for facilitating the truck's maneuverability and function, and the capability of being utilized with or without the debris bin. Therefore, the present invention is directed to the provision of such improvements.

### ASPECTS AND SUMMARY OF THE INVENTION

This invention relates to a wheeled hand truck system having a removable and/or stackable bin or container formed by sidewalls and a bottom surface, the container having a plurality of leg slots and strap slots on one or more of the side walls, and a plurality of base plates secured to or formed with the exterior of the bottom surface and configured for engaging with a load supporting platform or support blade of a hand truck. The truck may be configured for utilization of one or more bins or containers. More specifically, provided is a combination hand truck and bin that comprises a body, a load supporting platform or support blade, an axle, a wheel assembly having a pair of wheels, a bin or container, and a restraining device for retaining the bin or container securely on the platform or blade of the hand truck.

Disclosed is a hand truck bin comprising a plurality of side walls, and a bottom wall, the side walls in combination with the bottom wall forming an interior cavity therebetween, the bottom wall disposed to act as a floor within the interior cavity when the bin is placed in a vertical position; one or more base plates removably secured to an exterior surface of the bottom wall, the base plates configured so as to form an opening between the exterior surface of the bottom wall and an upper surface of the base plates for engaging with a support platform of a hand truck; and a fastening device for removably securing the bin to the hand truck. Optionally, a handle is provided at an upper end of the hand truck for maneuvering the hand truck, and one or more wheels joined by an axle are carried on a first end of the hand truck for moving the truck.

The bin according to the invention further comprises a protrusion carried on the bottom of the bin and a recessed area formed on the upper edge of the bin to cooperatively engage with one another when a first bin is placed on top of a second bin, thereby removably stacking a plurality of bins. Accordingly, the bin further comprises an upper lip around the circumference of an upper end of the cavity to assist in inserting and removing the bin from the hand truck. The bin further comprises a slot or space formed in a region adjacent to the bottom wall for insertion of a blade of said hand truck. The bin further comprises a plurality of slits formed on at least one side wall for the securing of a strap of the fastening device, wherein the fastening device is selected from the group consisting of straps, belts, strings, or elastic cords. Also, a central region of the bottom wall comprises a raised portion extending a length of said bottom wall. The bin may be made from a material selected from the group consisting of plastic, metals, bamboo, and wood.

Also disclosed is a hand truck and removable container assembly comprising an elongated body; a support platform extending away from a lower end of the body; a handle portion configured integral with an upper portion of the body; an axle secured in a fixed relationship to the body; at least a pair of wheels located at the lower end of the body; and a container comprising a plurality of side walls, and a bottom wall, the side walls in combination with the bottom wall forming an interior cavity therebetween, the bottom wall disposed to act as a floor within the interior cavity when the container is placed in a vertical position; one or more base plates removably secured to an exterior surface of the bottom wall, the base plates configured so as to form an opening between the exterior surface of the bottom wall and an upper surface of the base plates for engaging with a support platform of the hand truck; and a fastening device for removably securing the bin to the hand truck.

The support platform is optionally movable, the movable work support member being moveable between a first position in which a free end portion of the movable work support member rests on the fixed work support member, and a second position in which the free end portion of the movable work support member is spaced apart from the fixed work support member.

Thus, an aspect, feature, and advantage of the present invention is to provide a new and improved hand truck with a removable debris bin.

Another aspect, feature, and advantage of the present invention is to provide a new and improved hand truck that can be utilized with the removable debris bin.

It is also an aspect of the present invention to provide a new and improved hand truck for easy removal of carried objects which has all the advantages of the prior art hand trucks of various designs and configurations and none of the disadvantages.

It is another aspect of the present invention to provide a new and improved hand truck for easy removal of carried objects which may be easily and efficiently manufactured and marketed.

It is a further aspect of the present invention to provide a new and improved hand truck for easy removal of carried objects which is of a durable and reliable construction.

An even further aspect of the present invention is to provide a new and improved hand truck for easy removal of carried objects which is susceptible of a low cost of manufacture with regard to both materials and labor, and which accordingly is then susceptible of low prices of sale to the consuming public, thereby making such hand trucks of various designs and configurations economically available to the buying public.

Still yet another aspect of the present invention is to provide a new and improved hand truck for easy removal of carried objects which provides in the apparatuses and methods of the prior art some of the advantages thereof, while simultaneously overcoming some of the disadvantages normally associated therewith.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows a perspective view of a loaded fastenable hand truck bin according to the preferred embodiment of the present invention, further illustrating a user of such hand truck bin;

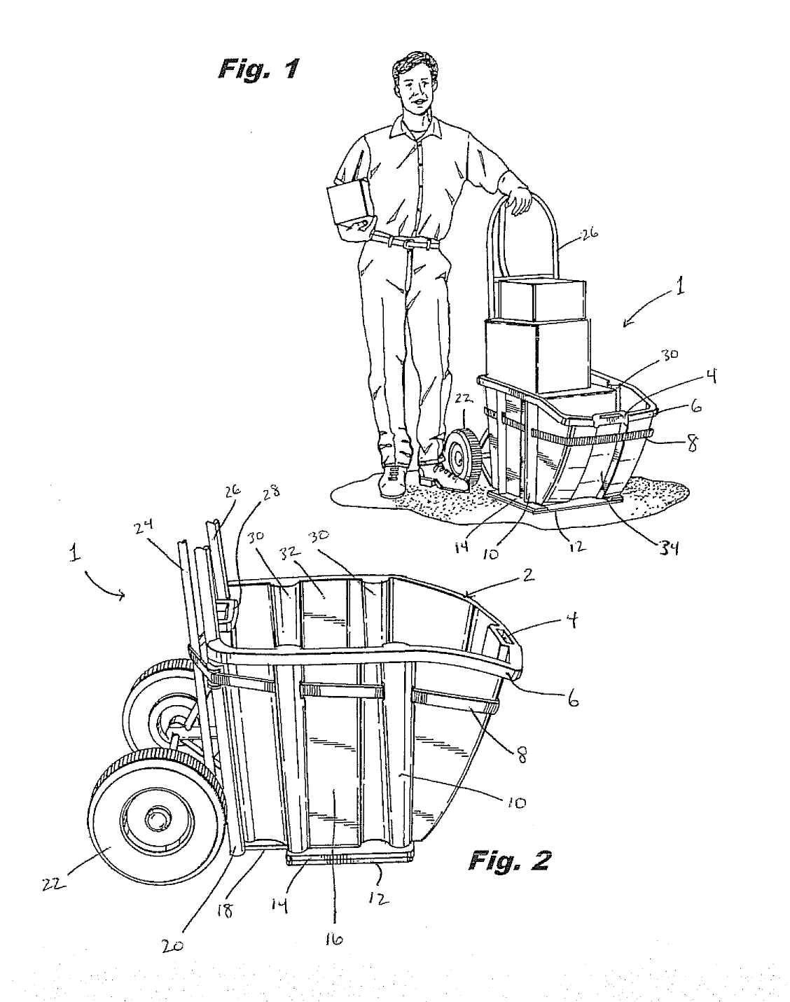

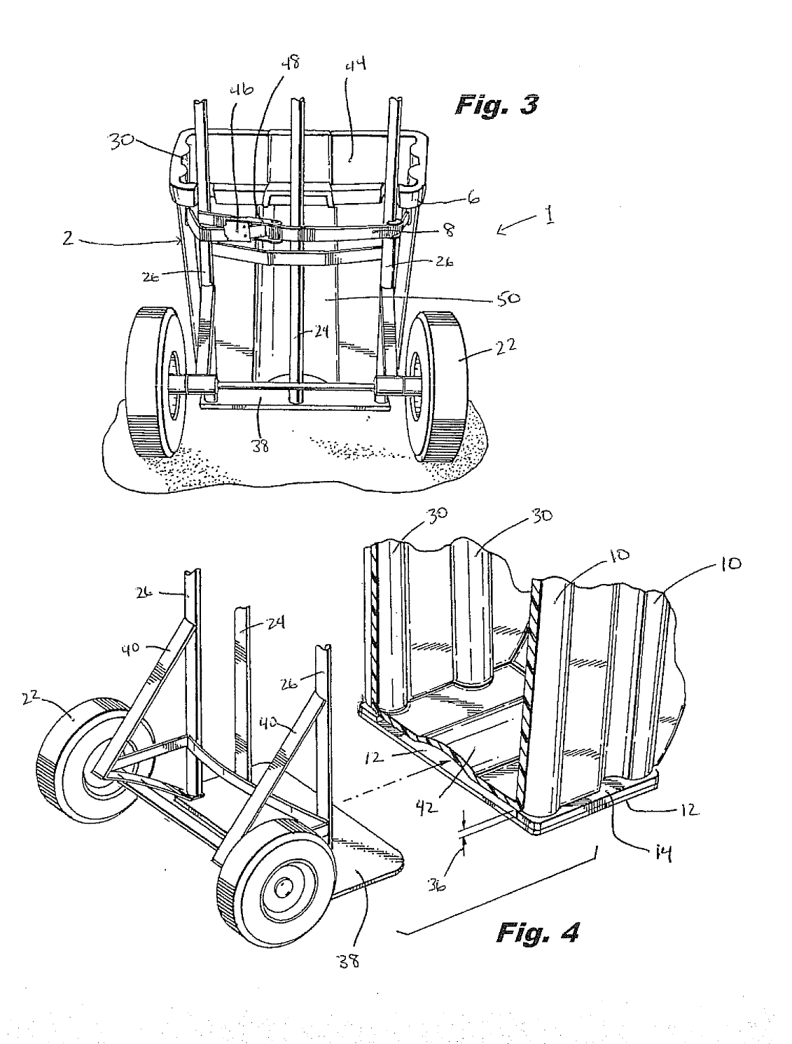

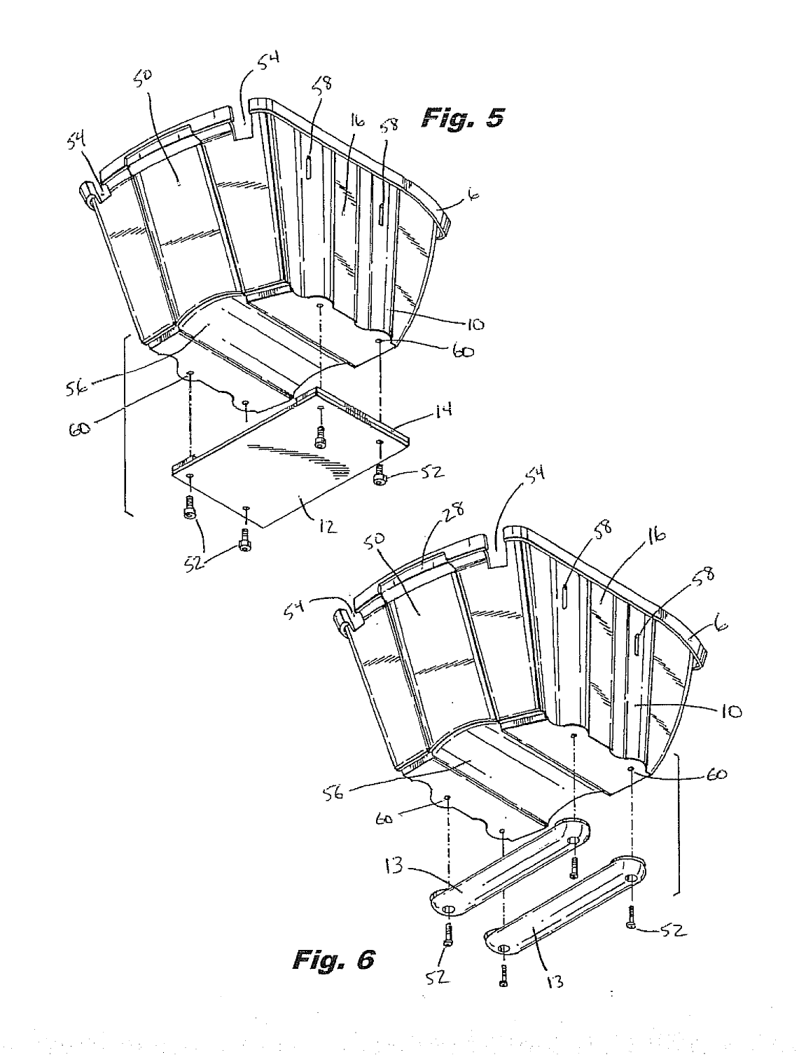

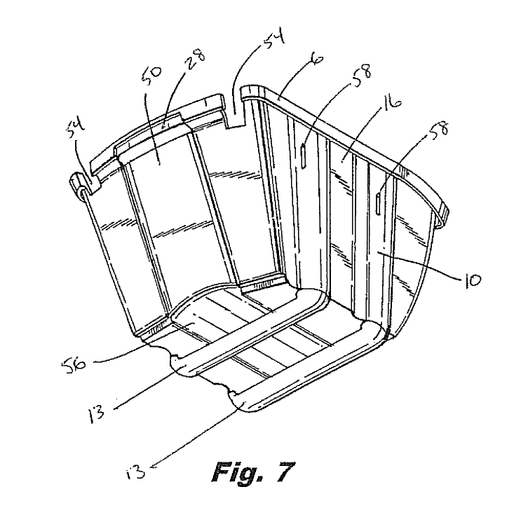

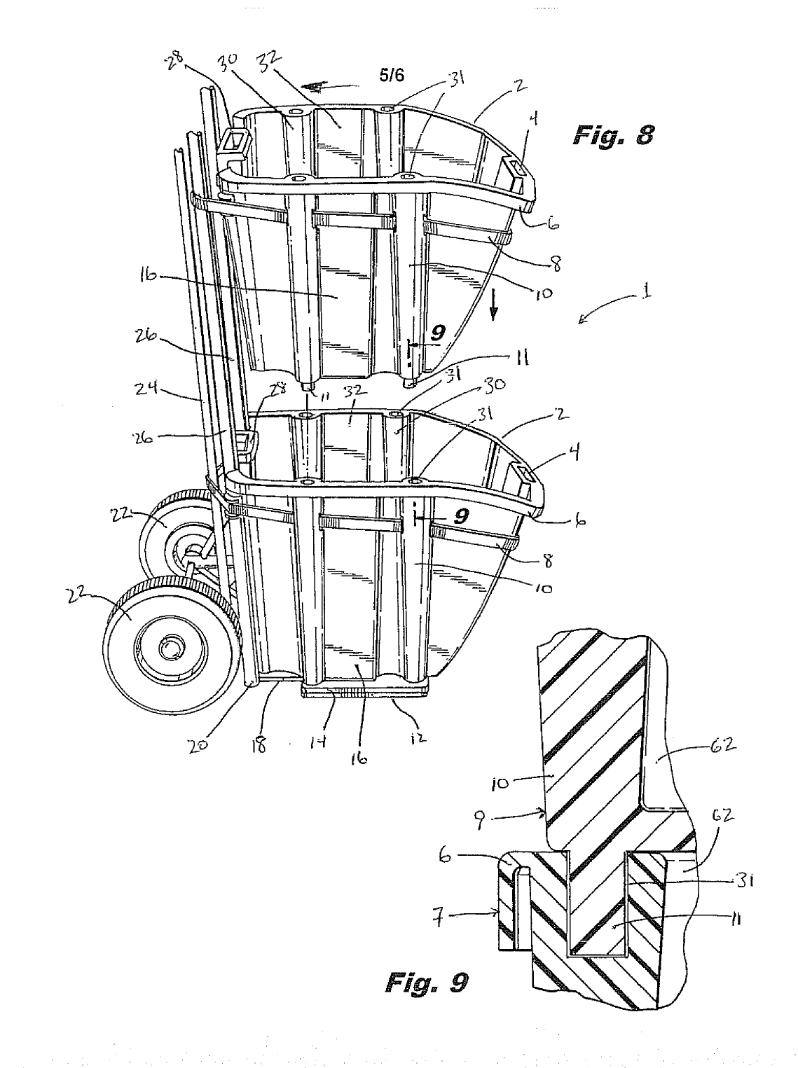

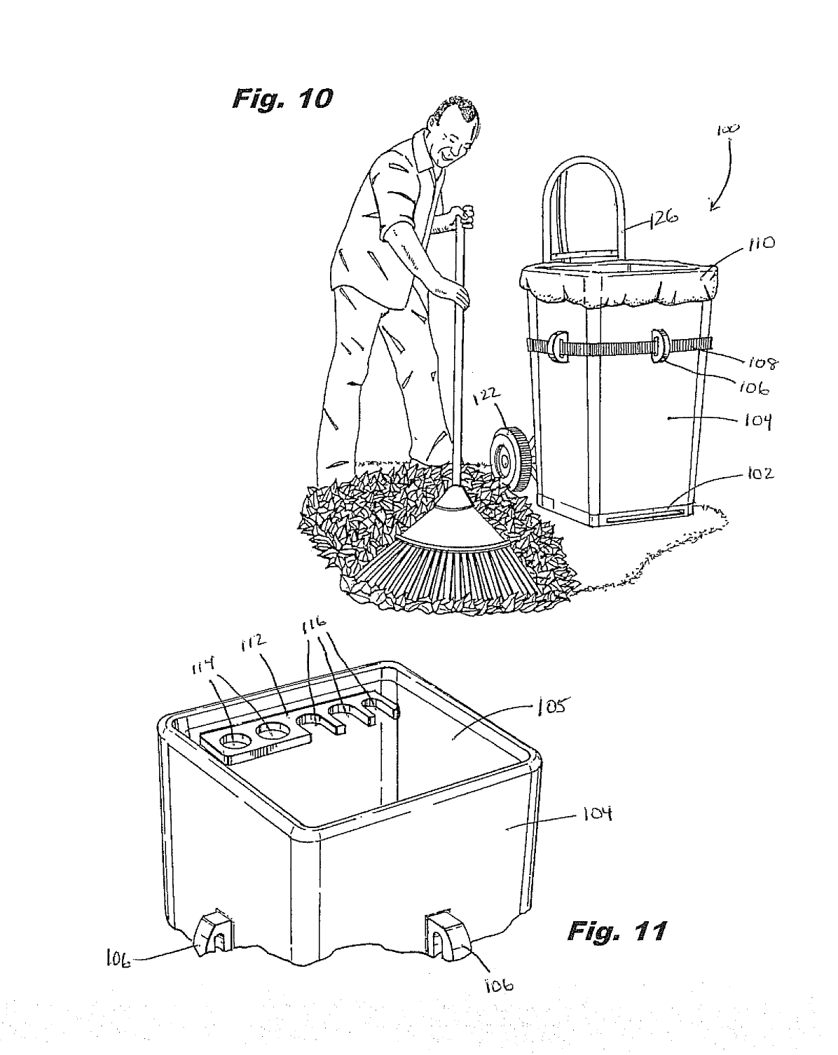

FIG. 2 shows a side perspective view of the fastenable hand truck bin according to the preferred embodiment of the present invention;

FIG. 3 shows a rear perspective view of the fastenable hand truck bin shown in FIG. 2;

FIG. 4 shows a rearward perspective partially exploded, partially cut-away view of the fastenable hand truck bin shown in FIG. 2;

FIG. 5 shows a bottom perspective partially exploded view of the fastenable hand truck bin shown in FIG. 2;

FIG. 6 shows a bottom perspective partially exploded view of the fastenable hand truck bin according to an alternate embodiment of the present invention;

FIG. 7 shows an assembled bottom perspective view of the fastenable hand truck bin shown in FIG. 6;

FIG. 8 shows side perspective partially exploded view of the fastenable hand truck bin according to yet another alternate embodiment of the present invention;

FIG. 9 shows a partial cut-away assembled side view of the stackable bins according to the invention along line 9-9 of FIG. 8;

FIG. 10 shows a perspective view of a loaded fastenable hand truck bin according to still another embodiment of the present invention, further illustrating a user of such hand truck bin; and

FIG. 11 shows a partial perspective view of the bin shown in FIG. 10, further showing an optional equipment bracket or holder.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

With reference now to the drawings, and in particular to FIGS. 1-5, the preferred embodiment of the new and improved hand truck and bin 1 for efficient moving of carried objects and or debris embodying the principles and concepts of the present invention and generally designated by the reference numeral 1 will be described. The present invention, as shown, is a system 1 comprised of a plurality of components. In their broadest context, provided and shown is a combination hand truck and bin 1 that comprises a body 26, a load supporting platform or support blade 38, a wheel and axle assembly having at least a pair of wheels, a bin or container 2, and a restraining device 48 for retaining the bin or container 2 securely on the platform or blade 38 of the hand truck body 26. The container 2 preferably has a plurality of leg support slots or notches 54 and securing slots or openings 58 on one or more of the side walls 16, 34, 50, and a plurality of base plates 12, 14 secured to or formed with the exterior of the bottom surface 18 of the bin 2 and configured for engaging with the supporting platform or blade 38 of the hand truck. The bin 2 is preferably sized and shaped to accommodate a variety of sized objects or substantial amount of waste or debris, depending on the desire of the user.

As depicted in FIGS. 1-5, shown is one exemplary embodiment of fastenable or removable hand truck and bin 1 constructed in accordance with the preferred embodiment of the present invention. As shown, a hand truck includes an elongated main body or frame 26 having an upper end, a lower end, a front surface, and a rear surface. Although the hand truck shown is a utility type of hand truck, the teachings of the invention may be used with other types or styles of hand trucks or dollies. The upper end of the elongated body 26 preferably comprises a handle for a user to grasp in order to maneuver the hand truck during use. In some embodiments, the handle may be formed by the upper portion of the body 26 itself so that the handle is integral with the body 26. Preferably, hand truck body 26 further comprises a middle support leg 24 positioned longitudinally from the blade 38 to the upper end of the body 26.

At the lower end of the elongated body 26, a support platform or support blade 38 is provided and extends perpendicularly from the front surface of the lower end of the body 26. The support platform 38 includes front and rear edges, and top and bottom surfaces. Although the platform 38 is shown as being fixedly secured to the body 26, in some embodiments, the blade 38 may be pivotally mounted to the body 26 so that the blade 38, when not in use, may be pivoted into a compact and parallel relationship with the body 26.

A pair of axle support members 40 are preferably secured to the rear side of the lower end of the body 26. The members 40 may optionally extend from the rear side of the lower end of the body 26 to the rear of the support platform 38, as more clearly shown in FIG. 4. The members 40 may be secured to the body 26 and the support blade 38 by any suitable means, such as welds, pins, fasteners, or screws. To connect and maintain the wheels in a fixed position with respect to the body 26, an axle is welded or otherwise secured to the support members 40, as shown in FIG. 4. The term “axle” as described and claimed in this application includes both a single member or a pair of members or shafts. As the members 40 are welded or otherwise fixedly secured to the body 26, the axle will be movable with the main body or frame 26, as will be described in greater detail hereinafter.

A wheel assembly, including a pair of wheels 22, is located at the lower end of the body or frame 26. Each of the wheels 22 is preferably mounted adjacently to opposing ends of the axle. As shown in FIGS. 2 and 4, each of the wheels 22 has an annular inner race or hub that is surrounded by an outer ground-engaging annular race including a tread portion that may be a solid rubber-like material, an inflatable tire material, or any other suitable material. The inner and outer races are freely rotatable about each other via bearings or other means positioned intermediate the inner and outer races.

Load or debris container or bin 2 is preferably and generally configured with an open top end and is, more particularly, defined by side walls 16, 34, 50, and bottom wall or surface 18. The container 2 preferably has a plurality of leg support slots or notches 54 and securing slits or openings 58 on one or more of the side walls 16, 34, 50, and a plurality of base plates 12, 14 secured to or formed with the exterior of the bottom surface 18 of the bin 2 and configured for engaging with the supporting platform or blade 38 of the hand truck. Formed on the exterior of side walls 16 are, preferably, projecting areas 10 to provide added support longitudinal strength to the bin 2. Optionally, rear corner support ribs 20 may be provided for additional longitudinal support to the bin 2. Formed on the interior 32 of side walls 16 are, optionally, projecting areas 30 to also provide added support longitudinal strength to the bin 2. Formed on the upper edge of front wall 34, rear wall 50 and side walls 16 is outwardly projecting lip 6 having a downwardly projecting portion 7 (see FIG. 9) preferably configured completely around the circumference of the upper open end of the bin 2. Lip 6 provides both added support strength to the bin 2 as well as means for gripping bin 2 in order to lift and or move the bin 2 in any direction. Optionally, lip 6 further comprises one or more integrated handles 4, 28.

As depicted in FIGS. 1-5, most clearly in FIG. 4, bin 2 comprises a plurality of base plates 12, 14 removably secured to the exterior of the bottom wall 18 of the bin 2. Base plate 12 is preferably sized to approximately match the size or shape of the bottom surface of the bin 2, while base plates 14 are sized much smaller than base plate 14. As seen in FIG. 5, base plate 14 is removably secured to the bottom of bin 2 with each of base plates 12 positioned therebetween on either end of the base plate 14 to provide a central gap 36 between base plate 14 and the exterior of the bottom surface 18 of the bin 2. Preferably, gap 36 is sufficiently sized to accept support platform or blade 38 to secure bin 2 onto blade 38 of the hand truck. In the preferred embodiment bottom surface 18 of the bin 2 has a raised (e.g., arched) portion 42 extending from the rear of the bin 2 toward the front of the bin 2 such that an air pocket is provided (see underside 56 of raised portion 42 in FIG. 5) so that blade or platform 38 does not become stuck or otherwise semi-permanently or permanently engaged within the gap 36. While the raised portion 42 is preferably arc-shaped, it is not limited to such shape or configuration, rather other shapes or sizes may be employed. While base plates 12, 14 are preferably may be manufactured utilizing high impact plastic materials such as that used for the bin 2 itself, and formed in accordance with traditional plastic molding processes, it will be apparent to those skilled in the art that base plates 12, 14 may be manufactured utilizing other known materials suitable for such use, such as light-weight and durable metals, wood, etc.

As shown in FIG. 5, base plates 12, 14 are preferably secured to the bin 2 using screws 52 connecting to the bin 2 via throughholes 60. It is noted, however, that any other conventional means for securing these base plates 12, 14 to the bottom of the bin 2 may be used, such as, for example, glue or other adhesive, rivets, hook and loop fasteners, snap fit connections, etc. Optionally, the configuration of base plates 12, 14 secured to bin 2 may be pre-formed in an integral manner through known molding techniques. Also provided is at least one securing strap 8 having fastening means 48. In order to provide an attaching means for strap 8, preferably, strap slits 58 are formed on one or more side walls 16, 34, 50 of the bin 2. Each strap slit 58 has an opposing strap slit 58 generally positioned directly across on the opposite side wall for balance in securing the bin 2. In use, strap 8, extending through strap slits 58, are utilized to help secure the bin 2 with the hand truck during use. Optionally, fastening means 48 is a ratchet system with ratchet handle 46 to manipulate and secure strap 8 tightly around the bin 2.

In accordance with the present invention, bin or container 2 may be manufactured using high impact plastic materials such as those well-known in the art, and formed in accordance with traditional plastic molding processes. It will, however, be apparent to those skilled in the art that bin 2 may be manufactured using other known materials suitable for such use, such as light-weight and durable metals, wood, etc. It will also be apparent to those ordinarily skilled in the art that the bin 2 may be provided with a front wall 34 having an outward taper according to traditional wheelbarrow designs for easy emptying of the contents being transported. Optionally, bin 2 may be provided with side walls 16 having similarly outwardly tapering walls.

Still in accordance with the invention, bin or container 2 may be provided in varying shapes and sizes to accommodate application of the apparatus in a variety of fields of use. Similarly, bin 2 may be provided with any of a variety of paper or plastic liners for catching and holding objects or debris, and for the user's ease in disposal of such contents. Furthermore, without departing from either the scope or spirit of the present invention, it will be apparent to those skilled in the art that the bin 2 may employ protrusions 11 and mating recessed areas 31 (see FIGS. 8-9), to provide stackable bins in accordance with the invention. The locations of protrusions 11 and recessed areas 31 may be varied about the periphery of the bin 2 in order to suit the configuration of apparatus and the needs of the field of application of the invention.

Turning next to FIGS. 6-7, shown is an alternate embodiment of the removable hand truck bin 2 according to the present invention. As depicted, the alternative embodiment of container 2 preferably has, like the bin 2 of FIGS. 1-5, load or debris container or bin 2 is preferably and generally configured with an open top end and is, more particularly, defined by side walls 16, 34, 50, and bottom wall or surface 18. The container 2 preferably has a plurality of leg support slots or notches 54 and securing slits or openings 58 on one or more of the side walls 16, 34, 50, and a plurality of base plates 12, 14 secured to or formed with the exterior of the bottom surface 18 of the bin 2 and configured for engaging with the supporting platform or blade 38 of the hand truck. Formed on the exterior of side walls 16 are, preferably, projecting areas 10 to provide added support longitudinal strength to the bin 2. Optionally, rear corner support ribs 20 may be provided for additional longitudinal support to the bin 2. Formed on the interior 32 of side walls 16 are, optionally, projecting areas 30 to also provide added support longitudinal strength to the bin 2. Formed on the upper edge of front wall 34, rear wall 50 and side walls 16 is outwardly projecting lip 6 preferably configured completely around the circumference of the upper open end of the bin 2. Lip 6 provides both added support strength to the bin 2 as well as means for gripping bin 2 in order to lift and or move the bin 2 in any direction. Optionally, lip 6 further comprises one or more integrated handles 4, 28. Here too the bin 2 is preferably sized and shaped to accommodate a variety of sized objects or substantial amount of waste or debris, depending on the desire of the user.

As depicted in FIGS. 6-7, an alternate embodiment of bin 2 comprises one or more base plates 13 removably secured to the exterior of the bottom wall 18 of the bin 2. The length of base plate(s) 13 is(are) preferably sized to approximately match the side-to-side width of the bottom surface of the bin 2, preferably configured so as to connect to the bottom surface 18 of bin 2 at locations adjacent to bottom ends of the support portions 10. As seen in FIG. 6, base plates 13 are removably secured to the bottom of bin 2 and are each configured to provide a central gap between base plate 13 and the exterior of the bottom surface 18 of the bin 2. Preferably, like gap 36 discussed above, the gap formed by base plates 13 is sufficiently sized to accept support platform or blade 38 to secure bin 2 onto blade 38 of the hand truck. Here too, it is generally preferred that bottom surface 18 of the bin 2 has a raised (e.g., arched) portion 42 extending from the rear of the bin 2 toward the front of the bin 2 such that an air pocket is provided (shown as the underside 56 of raised portion 42 in FIGS. 6-7) so that blade or platform 38 does not become stuck or otherwise semi-permanently or permanently engaged within the gap 36. While the raised portion 42/56 is preferably arc-shaped, it is not limited to such shape or configuration, rather other shapes or sizes may be employed. While base plates 13 are preferably may be manufactured of high impact plastic materials such as that used for the bin 2 itself, and formed in accordance with traditional plastic molding processes, it will be apparent to those skilled in the art that base plates 13 may be manufactured of other known materials suitable for such use, such as light-weight and durable metals, wood, etc.

Referring now to FIGS. 8-9, shown is yet another alternate embodiment of the removable hand truck bin 1 according to the present invention, further showing (FIG. 9) a partial cut-away assembled side view of the stackable bins according to the invention. As shown, the removable hand truck bin 1 utilizes a bin 2 preferably configured as described hereinabove with respect to FIGS. 1-5 or alternatively as described with respect to FIGS. 6-7, but additionally comprises a plurality of protrusions or legs or feet 11 on predetermined support locations near the edges of the bottom surface 18 and a plurality of corresponding and mating recessed areas or openings 31 at predetermined locations along the upper surface of lip portion 6 so as to receive, mate or correspond with legs or feet 11 of another bin 2 to provide stackable bins in accordance with the invention. The locations of protrusions 11 and recessed areas 31 may be varied about the periphery of the bin 2 in order to suit the configuration of apparatus and the needs of the field of application of the invention. As seen in FIG. 9, it is preferred that the protrusions 11 and recesses 31 are positioned such that, when engaged, the interior cavities 62 of the mating bins 2 do not overlap (i.e., one bin is not within another bin).

Turning next to FIGS. 10-11, shown is still another alternate embodiment of the fastenable hand truck and bin apparatus 100 according to the present invention, further illustrating an optional equipment bracket or holder 112. This embodiment, as shown, is an apparatus 100 also comprised of a plurality of components. As with the prior embodiments, provided and shown is a combination hand truck and bin 100 that comprises a standard hand truck 126 having a support platform or support blade, a wheel and axle assembly having at least a pair of wheels 122, a bin or container 104, and a restraining device (show here as restraining slots 106 and strap 108) for retaining the bin or container 104 securely on the hand truck. The container 104 preferably has a plurality of slots 106 around the exterior circumferentially with openings to accept and secure strap 108. The bin 104 also preferably has a slot or other opening 102 formed integral with the lower end of the bin 104 configured for engaging with the support platform or blade of the hand truck 126. Here, the bin 104 is shown as a generally tall bin having a generally square cross-sectional configuration, but it will be appreciated that the bin 104 may be sized and shaped to accommodate a variety of sized objects or substantial amount of waste or debris, depending on the desire of the user. Optionally, the bin 104 may be configured to accept and/or utilize a paper, plastic or otherwise liner or bag for easy disposal of the debris or other contents for which the apparatus 100 is used to collect and or transport.

As more clearly seen in FIG. 11, shown is one exemplary embodiment of fastenable or removable hand truck bin 104 constructed in accordance with the preferred embodiment of the present invention with an optional equipment bracket or holder 112. While holder 112 is preferably positioned such that the equipment, tools, etc. may be maintained within the interior cavity 105 of the bin 104, it will be appreciated that holder 112 may be located on the exterior of the bin 104. Preferably, holder 112 comprises a plurality of connections for securing various tools or equipment in place during transport. Such connections may include U-shaped openings 116 or round holes 114. Of course, these connections are not limited to being U-shaped or round, and rather may take on any number of shapes or sizes to suit the particular use of the apparatus 100.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A hand truck bin system, said bin comprising:
a plurality of side walls, and a bottom wall, said side walls in combination with said bottom wall forming an interior cavity therebetween, said bottom wall disposed to act as a floor within said interior cavity when said bin is placed in a vertical position;
one or more base plates removably secured to an exterior surface of said bottom wall, said base plates configured so as to form an opening between said exterior surface of said bottom wall and an upper surface of said base plates for engaging with a support platform of a hand truck; and
a fastening device for removably securing said bin to said hand truck.

2. The hand truck bin system according to claim 1, wherein a handle is provided at an upper end of said hand truck for maneuvering said hand truck.

3. The hand truck bin system according to claim 1, wherein one or more wheels are carried on a first end of said hand truck for moving said truck, and wherein said one or more wheels are joined by an axle.

4. The hand truck bin system according to claim 1, further comprising at least one protrusion carried on said bottom wall of a first bin and at least one recessed portion formed on an upper edge of said side walls of a second bin, wherein said at least one protrusion cooperatively engages said at least one recessed area when said first bin is placed on top of said second bin.

5. The hand truck bin system according to claim 1, further comprising an upper lip around the circumference of an upper end of said cavity to assist in inserting and removing said bin from said hand truck.

6. The hand truck bin system according to claim 1, further comprising a slot formed in a region adjacent to said bottom wall for insertion of a blade or said hand truck.

7. The hand truck bin system according to claim 1, further comprising a plurality of slits formed on at least one said side wall for the securing of a strap of said fastening device.

8. The hand truck bin system according to claim 1, wherein said fastening device is selected from the group consisting of straps, belts, strings, or elastic cords.

9. The hand truck bin system according to claim 8, wherein said strap is inserted through at least one of a plurality of slits to restrain said bin on said hand truck.

10. The hand truck bin system according to claim 1, wherein a central region of said bottom wall comprises a raised portion extending a length of said bottom wall

11. The hand truck bin system according to claim 1, wherein said bin is made from a material selected from the group consisting of plastic, metals, bamboo, and wood.

12. A hand truck and removable container assembly, said assembly comprising:
an elongated body;
a support platform extending away from a lower end of said body;
a handle portion configured integral with an upper portion of said body;
an axle secured in a fixed relationship to said body;
at least a pair of wheels located at said lower end of said body; and
a container system comprising:
a plurality of side walls, and a bottom wall, said side walls in combination with said bottom wall forming an interior cavity therebetween, said bottom wall disposed to act as a floor within said interior cavity when said container is placed in a vertical position;
one or more base plates removably secured to an exterior surface of said bottom wall, said base plates configured so as to form an opening between said exterior surface of said bottom wall and an upper surface of said base plates for engaging with a support platform of said hand truck; and
a fastening device for removably securing said bin to said hand truck.

13. The assembly according to claim 12, wherein said support platform is movable, said movable work support member being moveable between:
(i) a first position in which a free end portion of said movable work support member rests on said body, and
(ii) a second position in which said free end portion of said movable work support member is spaced apart from said body.

14. The assembly according to claim 12, wherein a handle is provided at an upper end of said hand truck for maneuvering said hand truck.

15. The assembly according to claim 12, wherein one or more wheels are carried on a first end of said hand truck for moving said truck, and wherein said one or more wheels are joined by an axle.

16. The assembly according to claim 12, further comprising at least one protrusion carried on said bottom wall of a first bin and at least one recessed portion formed on an upper edge of said side walls of a second bin, wherein said at least one protrusion cooperatively engages said at least one recessed area when said first bin is placed on top of said second bin.

17. The assembly according to claim 12, further comprising an upper lip around the circumference of an upper end of said cavity to assist in inserting and removing said bin from said hand truck.

18. The assembly according to claim 12, further comprising a slot formed in a region adjacent to said bottom wall for insertion of a blade or said hand truck.

19. The assembly according to claim 12, further comprising a plurality of slits formed on at least one said side wall for the securing of a strap of said fastening device.

20. The assembly according to claim 12, wherein said fastening device is selected from the group consisting of straps, belts, strings, or elastic cords.
